(19) United States
(12) Patent Application Publication
(10) Pub. No.: US 2009/0161802 A1
(43) Pub. Date: Jun. 25, 2009

(54) RECEIVER WITH ADAPTIVE POWER CONSUMPTION AND A METHOD IMPLEMENTED THEREIN

(75) Inventors: Pukar Malla, Hillsboro, OR (US); Hasnain Lakdawala, Beaverton, OR (US); Soumyanath Krishnamurthy, Portland, OR (US)

Correspondence Address: GROSSMAN, TUCKER, PERREAULT & PFLEGER, PLLC;c/o CPA Global, P. O. BOX 52050, MINNEAPOLIS, MN, 55402, US

(73) Assignee: INTEL CORPORATION, Santa Clara, CA (US)

(21) Appl. No.: 11/963,482

(22) Filed: Dec. 21, 2007

(51) Int. Cl. H04L 27/08; H04B 1/10

(52) U.S. Cl. 375/345; 375/346

(57) ABSTRACT

A receiver and a method for controlling power consumption therein are disclosed. The receiver comprises at least one front-end module, an amplifier, an Analog to Digital Converter (ADC) module, a spectrum analyzer and a control module. The at least one front-module is configured to receive and process a RF signal to obtain an IF signal. The amplifier is configured to amplify the IF signal received from the at least one front-end module with a variable gain. The ADC module receives the amplified IF signal and converts into a digital signal. Further, the spectrum analyzer estimates a power level of a signal information and a power level of a noise in the digital signal. Thereafter, the control module controls a variable gain of the amplifier and a variable dynamic range of the ADC based on the power level of the signal information and the noise in the digital signal.

### FIELD OF THE DISCLOSURE

The present disclosure generally relates to radio receivers, and, more particularly, to a multi-standard radio receiver having adaptive power consumption and a method for controlling the power consumption of the multi-standard radio receiver.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a schematic diagram illustrating a prior art multi-standard radio receiver;

FIG. 2 is a schematic diagram illustrating a multi-standard radio receiver, according to an exemplary embodiment of the present disclosure;

FIG. 3 is a graph illustrating various settings of a dynamic range of an analog to digital converter and a variable gain of an amplifier of the multi-standard radio receiver, according to an exemplary embodiment of the present disclosure; and

FIG. 4 is a flow diagram illustrating a method for controlling a power consumption of a multi-standard radio receiver, according to an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference has to be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

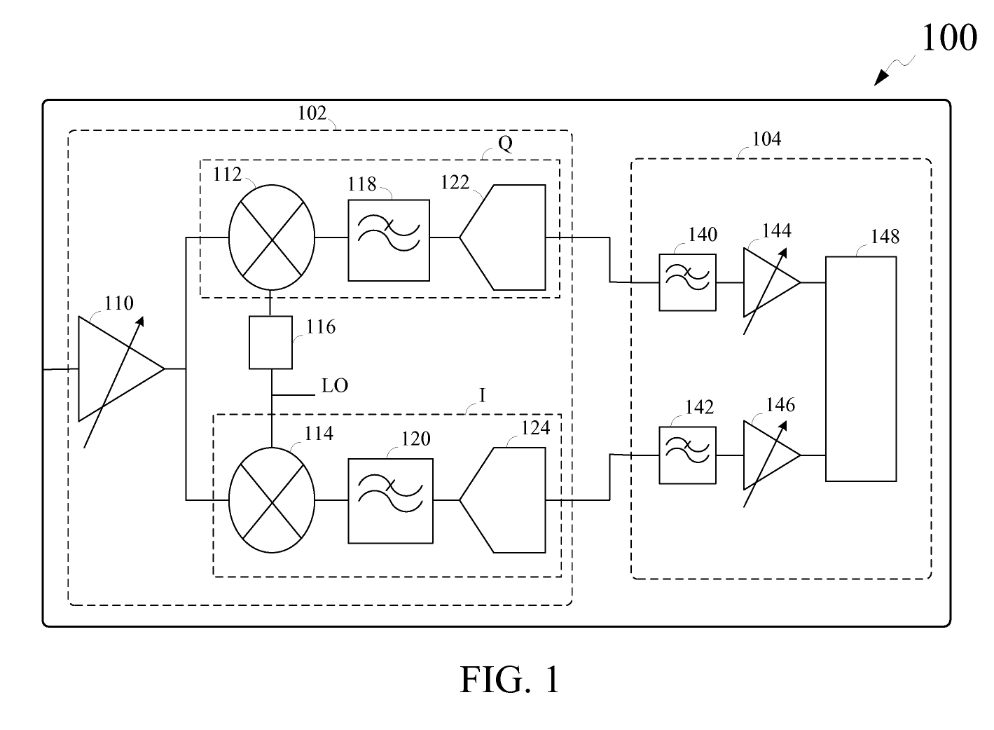

FIG. 1 is a circuit diagram illustrating a conventional multi-standard radio receiver 100 (hereinafter referred to as ‘receiver 100’). The receiver 100 comprises an analog module 102 and a digital module 104. The analog module 102 may comprise a low noise amplifier (LNA) 110, mixers 112 and 114, low-order filters 118 and 120, and Analog-to-Digital converters (ADC) 122 and 124. As shown in FIG. 1, the mixer 112, the low-order filter 118 and the ADC 122 may correspond to a quadrature path. The quadrature path is shown as ‘Q’ in the FIG. 1. The quadrature path (Q) may further comprise a phase shifter 116, which shifts a phase of a Local Oscillator (LO) frequency. Further, the mixer 114, the low-order filter 120 and the ADC 124 may correspond to in-phase path of the receiver 100. The in-phase path is shown as ‘I’ in the FIG. 1. Further, the LNA 110, the mixers 112 and 114, and the low-order filters 118 and 120 may be collectively referred to as a ‘front-end’ of the receiver. The digital module 104 may comprise channel filters 140 and 142, variable gain amplifiers 144 and 146, and a signal processor 148.

The front-end of the receiver 100 receives an input Radio Frequency (RF) signal and converts the input RF signal into an intermediate frequency (IF) signal. More specifically, the mixers 112 and 114 perform the frequency conversion of the input RF signal by mixing the RF signal with a LO frequency to obtain the IF signal. The LO frequency is phase shifted by the phase shifter 116 for the quadrature path. Further, the low-order filters 118 and 120 restrict the IF signal to a fixed-band IF signal. The fixed-band IF signal is then transmitted to the ADCs 122 and 124, which convert the fixed-band IF signal to a digital signal. Further, the digital signal may be provided to the digital module 104, which demodulates the digital signal to obtain information present in the input RF signal.

The input RF signal received at the front-end of the receiver 100 may contain a blocker signal, which may include interference from other communication devices, illegal transmissions, misdirected antennas or interference induced by circuits in the receiver 100 itself. The front-end of the receiver 100 may further introduce noise in the input RF signal, which is added to the blocker signal. Due to the presence of the blocker signal, a value of gain of the front-end (prior to the ADCs 122 and 124) needs to be controlled. Further, the low-order filters 118 and 120 of the receiver 100 are preferably selected from digital filters to simplify design of the analog module 102. The maximum gain of the front-end is limited by 1) the largest blocker signal 2) the filtering of the blocker signal. The limitation on the maximum gain of the front-end may be critical to the working of the receiver 100, which is designed to handle a maximum value of the blocker signal. A preferred solution to balance the limitation on the maximum gain of the front-end of the receiver 100 may be to increase a dynamic range of the ADCs 122 and 124. Further, in a practical scenario, the value of input RF signal and the blocker signal is variable. Accordingly, a power consumption of the receiver 100 must be adaptive to the change in the value of input RF signal and the blocker signal.

The present disclosure provides a receiver comprising an ADC module having a variable dynamic range. The present disclosure further provides a method implemented in the receiver for controlling the dynamic range of the ADC of the receiver based on the variation in the input RF signal and the blocker signal.

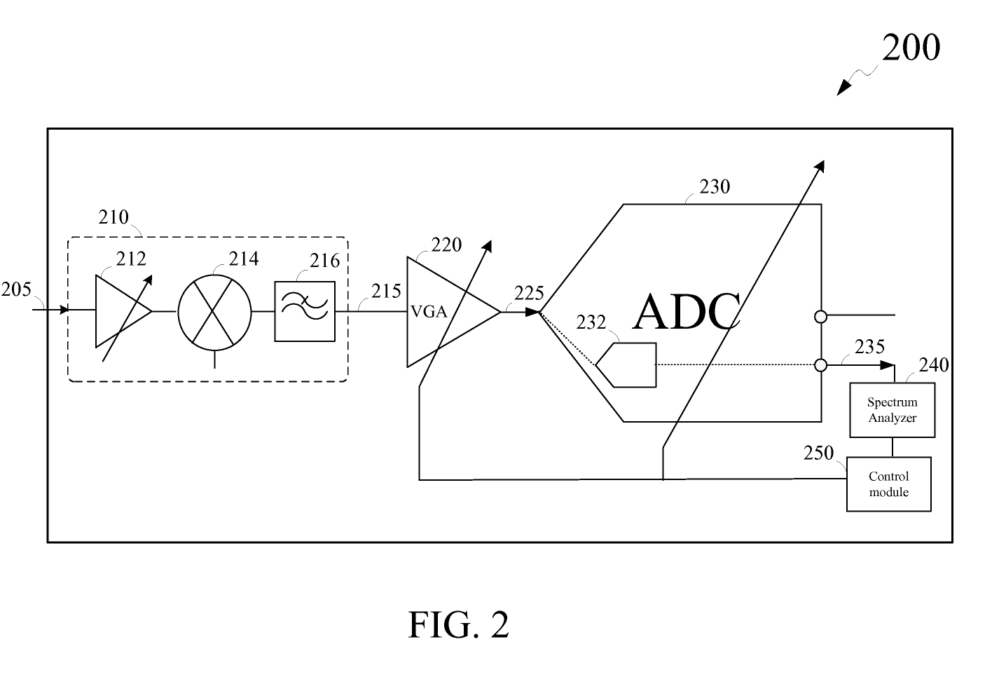

FIG. 2 is a schematic diagram illustrating a multi-standard radio receiver 200 (hereinafter referred to as ‘receiver 200’), according to an exemplary embodiment of the present disclosure. The receiver 200 comprises a front-end module 210, which is configured to receive an input signal 205, which is typically in form of an RF signal (represented as 205 in FIG. 2 and hereinafter referred to as ‘RF signal 205’). The RF signal 205 may contain the blocker signal. Further, the receiver 200 comprises an amplifier 220 and an ADC module 230. The amplifier 220 is connected to the front-end module 210 and the ADC module 230 is connected to the amplifier 220. The receiver 200 also comprises a spectrum analyzer 240 and a control module 250. The spectrum analyzer 240 is communicably coupled to the ADC module 230, and the control module 250 is communicably coupled to the spectrum analyzer 240. The spectrum analyzer 240 and the control module 250 may be connected to the ADC module 230 in series as shown in FIG. 2.

The front-end module 210 comprises a LNA 212, a mixer 214 and a low-order filter 216. For sake of simplicity, the front-end module 210 is shown to have a single frequency-conversion path. However, it will be obvious to a person skilled in the art that the front-end module 210 may also comprise multiple frequency conversion paths, such as the in-phase path and the quadrature path of the receiver 100. Of course, this embodiment may include a Q path similar to the Q path depicted in FIG. 1

The front-end module 210 performs similar functions as that of the front-end of the receiver 100. For example, the LNA 212 of the front-end module 210 performs amplification of the RF signal 205, the mixer 214 performs frequency conversion to convert the RF signal 205 into an IF signal. Further, the low-order filter 216 restricts the IF signal to a fixed-band IF signal. More specifically, the front-end module 210 processes the RF signal 205, which is the input RF signal to obtain the fixed band IF signal (shown as ‘signal 215’ in FIG. 2). The front-end module 210 may introduce noise in the RF signal 205, which may be added to the blocker signal, which may be already present in the RF signal 205. Therefore, the signal 215 may also contain the blocker signal. The signal 215 is supplied to the amplifier 220 by the front-end module 210.

The amplifier 220 has a variable gain, which is controlled by the control module 250. The amplifier 220 amplifies the signal 215 to obtain a signal 225. It will be evident that the signal 225 may also contain the blocker signal. Thereafter, the amplifier 220 transmits the signal 225 to the ADC module 230, which has a variable dynamic range. The ADC module 230 may be a Sigma-Delta type ADC comprising a flash ADC 232. However, it will be obvious to a person skilled in the art that any other type of ADC may also be utilized in the receiver 200. The flash ADC 232 of the ADC module 230 may quantize the signal 225 to a digital signal 235. It will be evident that the blocker signal present in the signal 225 may also be quantized by the flash ADC 232 along with the signal 225. Therefore, the digital signal 235 contains information about the signal 225 and the blocker signal. Thereafter, the digital signal 235 is transmitted to the spectrum analyzer 240.

The spectrum analyzer 240 processes the digital signal 235 to estimate a power level of a signal information and a power level of the blocker signal in the digital signal 235. The signal information may correspond to actual signal components present in the RF signal. For example, the signal 225 is obtained by subsequent processing of RF signal 205 by the front-end module 210 and the amplifier 220 of the receiver 200. Therefore, the digital signal 235, which is obtained from the signal 225, may be processed to obtain the power level of the actual signal components present in the RF signal 205.

The spectrum analyzer 240 transmits the estimated power level of the RF signal 205 and the blocker signal (obtained from the digital signal 235) to the control module 250. The control module 250 controls the power consumption of the receiver 200 based on the estimated power level of the signal information and the blocker signal in the digital signal 235. More specifically, the power consumption of the receiver 200 may be controlled by controlling the gain of the amplifier 220 and the dynamic range of the ADC module 230 based on the signal information and the blocker signal in the digital signal 235.

The dynamic range of the ADC module 230 may be defined as a function of a maximum power level of the signal 225, which is provided as an input to the ADC module 230 and an overall noise figure of the ADC module 230. An equation (1) below represents the dynamic range of the ADC module 230:

DR_{ADC}=U_{MAX}−N_{ADC} (1)

In the equation (1), DR_{ADC} is the dynamic range of the ADC module 230 in decibels (dB), U_{SIG} is the maximum power level of the signal content of the signal 225 in dBm, where the blocker is factored out of the signal, and N_{ADC} is the overall noise figure of the ADC module 230 in dBm.

The N_{ADC}, a noise introduced by the ADC module 230, may be further defined as a function of a thermal noise introduced by the front-end module 210, the gain of the amplifier 220 and the noise introduced by the AGC module 230. The N_{ADC} may be represented by equation (2) below:

N_{ADC}=N_{RADIO}+G_{VGA}−M (2)

In the equation (2), N_{RADIO} is a thermal noise level in dBm of the front-end module 210, G_{VGA} is the gain of the amplifier 220 in dB and M is the difference between N_{RADIO} and N_{ADC} in Db. Further, the receiver 200 may vary the G_{VGA} depending on the power level of the blocker signal to control the power consumption of the receiver 200. For example, a decrease in the power level of the blocker signal may be compensated by an increase in the G_{VGA}. Furthermore, the receiver 200 may control the dynamic range of the ADC module 230. Referring back to equation (1) and (2), the dynamic range of the ADC module 230 is controlled depending on U_{SIG} and the G_{VGA}. Accordingly, a control of the dynamic range of the ADC module 230 and the gain of the amplifier 220 controls the power consumption of the receiver 200.

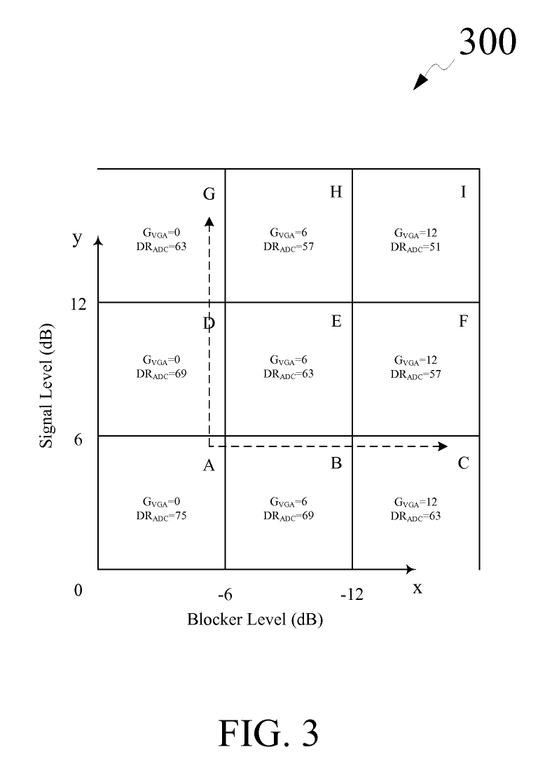

Referring now to FIG. 3, a graph 300 illustrating various settings of the DR_{ADC} and the G_{VGA} of the receiver 200 for a variation in the signal content of RF input 205 and the blocker signal, is shown. As described earlier, the variation in the power consumption of the receiver 200 may be controlled by controlling the DR_{ADC} and the G_{VGA} of the receiver 200. The X-axis of the graph 300 represents a power level of the blocker signal (in dBbmax) and the Y-axis of the graph 300 represents the power level of the RF signal 205 (in dBumin). dBbmax and dbumin refers to the dB ratio of the blocker and signal power to maximum blocker level of −40 dBm and −71 dBm respectively. The graph 300 is drawn by assuming three exemplary set of values of the gain of the amplifier 220 and five exemplary set of values of the dynamic range of the ADC module 230. For example, the graph 300 assumes the gain of amplifier as about 0 dB, 6 dB and 12 dB. Further, the graph 300 assumes a value of the dynamic range of the ADC module 230 as about 51 dB, 57 dB, 63 dB, 69 dB and 75 dB.

Further, the graph 300 is divided into nine regions denoted as region A to region I. The nine regions are formed by assuming three exemplary ranges of power level of the signal content of RF input 205 and three exemplary ranges of power level of the blocker signal. As shown in FIG. 3, the three ranges of the power level of signal content of the RF input 205 include ranges of about 0 dBumin to 6 dBumin, about 6 dBumin to 12 dBumin and above 12 dBumin. Also, the three ranges of the power level of the blocker signal include ranges of about 0 to −6 dBbmax, about −6 dBbmax to −12 dBbmax and lying below −12 dBbmax.

Each region of the nine regions represent an operation of the receiver for a particular range of the power level of the signal content of RF input 205 and the power level of the blocker signal. For example, region A represents a worst-case scenario for operation of the receiver 200. In region A, the power level of the blocker is in a range of 0 dBbmax to −6 dBbmax and the power level of the signal in RF input 205 is in a range of 0 dBumin to 6 dBumin. More precisely in the region A, the power level of the blocker signal is at a maximum range and the power level of the signal in RF input 205 is at a minimum range. Therefore, the receiver 200 may control the G_{VGA} to be about 0 dB and the DR_{ADC}, to be about 75 dB. Considering region A as a reference point to control the operation of the receiver 200, different cases may be considered by assuming different power levels of the blocker signal or the RF signal 205.

A first case of operation of the receiver 200 may be considered in which the power level of the signal in RF input 205 is assumed constant and the power level of the blocker signal is varied. In such a case, for a decrease in power level of the blocker signal by a particular amount, the receiver 200 may increase the G_{VGA} value by the same amount. For example, from region A to B to C, the power level of the input RF signal 205 is constant, such as in a range of about 0 dBumin to 6 dBumin. Further, from region A to B, the power level of blocker signal decreases from −6 dBbmax to −12 dBbmax. In such a situation, the receiver 200 may increase the G_{VGA} from about 0 dB (in region A) to about 6 dB (in region B). At the same time, the DR_{ADC} is decreased by 6 dB from 75 dB to 69 dB. Therefore, G_{VGA} and DR_{ADC} in the receiver 200 are controlled based on the variation in the blocker signal. Similarly, the operation of the receiver 200 may be predicted for other ranges of the power level of blocker signal, such as −6 dBbmax to −12 dBbmax and below −12 dBbmax.

A second case of operation of the receiver 200 may be considered, in which the power level of the blocker signal may be constant and the power level of the signal in RF input 205 may be variable. In such a case, for an increase in power level of the RF signal 205 by a particular amount, the receiver 200 may increase the N_{ADC} value by the same amount. Referring back to equation (1), it will be evident that the increase in the N_{ADC} may decrease the DR_{ADC}. Therefore, the DR_{ADC} of the receiver 200 may be controlled based on the power level of the signal in RF input 205. For example, from region A to G, the power level of the blocker signal is constant, such as in a range of about 0 dB to −6 dBbmax. Further, from region A to D, the power level of signal in RF input 205, U_{SIG}, increases from about 0 dBumin to about 6 dBumin. In such a situation, the receiver 200 may decrease the DR_{ADC} from 75 dB to 69 dB. Therefore, the dynamic range of the ADC module 230 of the receiver 200 is controlled based on the variation in the RF signal 205. Similarly, the operation of the receiver 200 may be predicted for other ranges of the power level of the signal in RF input 205, such as 6 dBumin to 12 dBumin and above 12 dBumin.

Furthermore, the graph 300 may be used to predict the operation of the receiver 200 in a situation when both the blocker signal and the RF signal 205 are variable. For example, we may consider the operation of the receiver 200 in region E of the graph 300. It may be evident that the power level of the blocker signal decreases by 6 dB in the region E as compared to region A. As a result, the receiver 200 may increase the G_{VGA} in region E as compared to region A. Further, the power level of the RF signal 205 in the region E increases by 6 dB as compared to region A. Accordingly, the receiver 200 may decrease the DR_{ADC} in the region E as compared to the region A. Therefore, it may be concluded from the graph 300 that the receiver 200 varies the gain of the amplifier 220 (G_{VGA}) and the dynamic range of the ADC module 230 (DR_{ADC}) depending on the variation in the blocker signal and the RF signal 205.

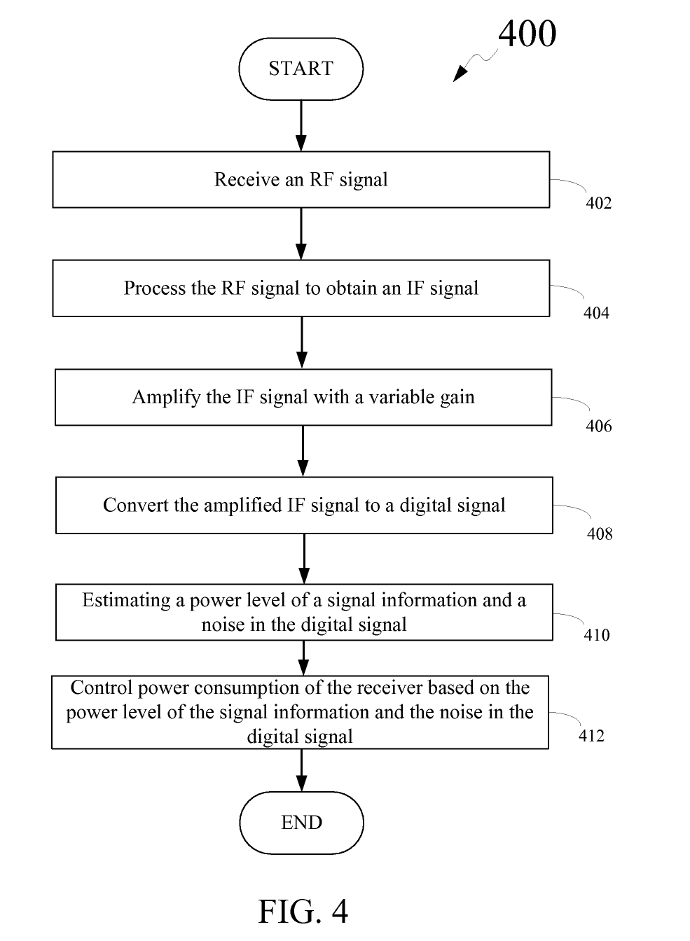

FIG. 4 is a flow diagram 400 illustrating a method for controlling the power consumption of the receiver 200. The power consumption of the receiver 200 is controlled by controlling the gain of the amplifier 220 and the dynamic range of the ADC module 230. At 402, the method comprises receiving the RF input 205. The RF signal 205 may contain the blocker signal and input signal, U_{SIG}. Further, the RF input 205 is received at an input of the front-end module 210. As stated earlier, the front-end module 210 performs frequency-conversion and frequency selection on the RF input 205 to obtain the signal 215. The front-end module 210 may introduce thermal noise in the blocker signal, which is present in the RF input 205. Thereafter, the RF input 205 is transmitted to the amplifier 220.

At 404, the signal 215 is amplified by the amplifier 220 to obtain the signal 225. The signal 225 is transmitted to the ADC module 230. Further, at 406, the ADC module 230 converts the signal 225 to a digital signal 235. The ADC module 230 may comprise a flash ADC 232, which quantizes the signal 225 along with the blocker signal to obtain the digital signal 235. The digital signal 235 is transmitted to the spectrum analyzer 240. At 408, the spectrum analyzer 240 estimates the power level of the signal information and the blocker signal in the digital signal 235. Further, the spectrum analyzer 240 estimates the power level of the blocker signal in the signal 225. Thereafter, the spectrum analyzer 240 transmits the estimated values of the signal information and the blocker signal in the digital signal 235 to the control module 250.

Further, at 410, the method comprises controlling the power consumption of the receiver 200. The power consumption of the receiver 200 is controlled by controlling the G_{VGA} and the DR_{ADC} based on the estimated values of the signal information and the blocker signal in the digital signal 235 to the control module 250. The control of the DR_{ADC} and the G_{VGA} has already been explained in conjunction with FIG. 3.

Various embodiments of the present disclosure offer following advantages. The receiver 200 provides the ADC module 230 having a variable dynamic range. As a result, the limitation on the maximum gain of the front-end module 210 may be compensated by varying the dynamic range of the ADC module 230. Further, the receiver 200 varies the gain of the amplifier 220 based on the variation in blocker signal in the RF signal 205. Accordingly, a power consumption of the receiver 200 may be controlled in an effective manner. Furthermore, the receiver 200 controls the dynamic range of the ADC module 230 based on a variation of the signal and the blocker signal in the RF input 205. Accordingly, the variation of the dynamic range of the ADC module 230 may further control the power consumption of the receiver 200.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

1. A receiver comprising:
at least one front-end module configured to receive a Radio frequency (RF) signal, the at least one front-end module adapted to process the RF signal to obtain an Intermediate frequency (IF) signal;
an amplifier configured to receive the IF signal from the at least one front-end module, wherein the amplifier is adapted to amplify the IF signal with a variable gain;
an Analog-to-Digital Converter (ADC) module coupled to the amplifier to receive the amplified IF signal, wherein the ADC module has a variable dynamic range and configured to convert the amplified IF signal to a digital signal;
a spectrum analyzer communicably coupled to the ADC module, the spectrum analyzer configured to estimate a power level of a signal information and a power level of a noise in the digital signal; and
a control module communicably coupled to the spectrum analyzer, the control module configured to control the variable gain of the amplifier and the variable dynamic range of the ADC based on the power level of the signal information and the power level of the noise in the digital signal.

2. The receiver of claim 1, wherein the ADC module comprises a Sigma-Delta ADC.

3. The receiver of claim 2, wherein the Sigma-Delta ADC comprises a Flash ADC.

4. The receiver of claim 1, wherein the noise in the digital signal comprises a blocker signal.

5. A method for controlling power consumption in a receiver, the receiver comprising at least one front-end module, an amplifier having a variable gain, and an Analog to Digital Converter (ADC) module, the method comprising:
receiving a Radio frequency (RF) signal by the at least one front-end module of the receiver;
processing the RF signal by using the at least one front-end module to obtain an Intermediate Frequency (IF) signal;
amplifying the IF signal by the variable gain amplifier;
converting the amplified IF signal into a digital signal by using the ADC module;
estimating a power level of a signal information and a power level of a noise in the digital signal; and
controlling the power consumption of the receiver by controlling a variable gain of the amplifier and a variable dynamic range of the ADC module based on the power level of the signal information and the power level of the noise in the digital signal by using a control module of the receiver.

6. The method of claim 5, wherein estimating the power level of the noise in the digital signal comprises estimating a power level of a blocker signal in the noise.

7. The receiver of claim 1, wherein said front-end module comprises an amplifier configured to amplify said RF signal to generate an amplified RF signal.

8. The receiver of claim 7, wherein said front-end module further comprises a mixer configured to convert said amplified RF signal to said IF signal.

9. The receiver of claim 8, wherein said front-end module further comprises a low-order filter configured to filter said IF signal to a fixed-band IF signal.

10. A system, comprising:
an Analog-to-Digital Converter (ADC) module configured to receive an amplified Intermediate frequency (IF) signal and convert the amplified IF signal to a digital signal;
a first circuit configured to estimate a power level of a signal information and a power level of a noise in the digital signal; and
a second circuit configured to control the variable dynamic range of the ADC based on the power level of the signal information and the power level of the noise in the digital signal.

11. The system of claim 10, further comprising:
at least one front-end module configured to receive a Radio frequency (RF) signal, the at least one front-end module adapted to process the RF signal to obtain said Intermediate frequency (IF) signal; and
an amplifier configured to receive the IF signal from the at least one front-end module, wherein the amplifier is adapted to amplify the IF signal with a variable gain.

12. The system of claim 11, wherein said second circuit is further configured to control the variable gain of the amplifier based on the power level of the signal information and the power level of the noise in the digital signal.

13. The system of claim 10, wherein estimating the power level of the noise in the digital signal comprises estimating a power level of a blocker signal in the noise.

14. The system of claim 11, wherein said front-end module comprises an amplifier configured to amplify said RF signal to generate an amplified RF signal.

15. The system of claim 14, wherein said front-end module further comprises a mixer configured to convert said amplified RF signal to said IF signal.

16. The system of claim 15, wherein said front-end module further comprises a low-order filter configured to filter said IF signal to a fixed-band IF signal.

17. The system of claim 10, wherein the ADC module comprises a Sigma-Delta ADC.

18. The system of claim 17, wherein the Sigma-Delta ADC comprises a Flash ADC.
